(19) United States
(12) Patent Application Publication
(10) Pub. No.: US 2012/0196019 A1
(43) Pub. Date: Aug. 2, 2012

(54) STEVIA SWEETENER WITH A SURFACTANT

(76) Inventors: Jingang Shi, Beijing (CN); Hansheng Wang, Shanxi (CN); Mingming Deng, Beijing (CN)

(21) Appl. No.: 13/362,673

(22) Filed: Jan. 31, 2012

Related U.S. Application Data
(60) Provisional application No. 61/438,392, filed on Feb. 1, 2011.

(51) Int. Cl. A23L 1/236

(52) U.S. Cl. 426/548

(57) ABSTRACT

The invention describes compositions that include a stevia sweetener and a surfactant, wherein the concentration of the components provide an improved taste profile where bitterness, after taste and/or lingering of the stevia sweetener is decreased or eliminated.

### CROSS REFERENCE TO RELATED APPLICATIONS

This application claims benefit under 35 U.S.C. §119(e) to U.S. Provisional Patent Application Ser. No. 61/438,392, filed Feb. 1, 2011, entitled “Stevia Sweetener with a Surfactant”, the contents of which is incorporated herein by reference in its entirety.

### FIELD OF THE INVENTION

The invention relates generally to compositions of stevia sweeteners that include one or more surfactants. It is believed that the use of surfactants helps to eliminate the associated bitter aftertaste associated with stevia sweeteners.

### BACKGROUND OF THE INVENTION

Stevia is a genus of about 240 species of herbs and shrubs in the sunflower family (Asteraceae), native to subtropical and tropical South America and Central America.

The species Stevia rebaudiana Bertoni, commonly known as sweet leaf; sugarleaf, or simply stevia, is widely grown for its sweet leaves. The leaves have traditionally been used as a sweetener. Steviosides and rebaudiosides are the major constituents of glycosides found in the leaves of the stevia plant.

Stevia extracts generally contain a high percentage of the glycosides of the diterpene steviol. The leaves of stevia rebaudiana contain 10 different steviol glycosides. Steviol glycosides are considered high intensity sweeteners (about 250-300 times that of sucrose) and have been used for several years in a number of countries as a sweetener for a range of food products. Stevioside and rebaudioside A are the principal sweetening compounds and generally accompanied by smaller amounts of other steviol glycosides. The taste quality of rebaudioside A is better than stevioside, because of increased sweetness and decreased bitterness (Phytochemistry 68, 2007, 1855-1863).

The structures and chemical abstract service registry numbers for steviol and its glycosides that are the main sweetening agents of the additive steviol glycosides are shown below:

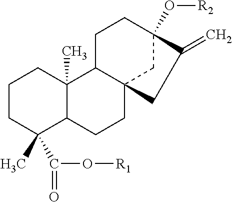

| | Compound | | | |
|---|---|---|---|---|
| | name | C.A.S. No. | R₁ | R₂ |
| 1 | Steviol | 471-80-7 | H | H |
| 2 | Steviolbioside | 41093-60-1 | H | β-Glc-β-Glc(2→1) |
| 3 | Stevioside | 57817-89-7 | β-Glc | β-Glc-β-Glc(2→1) |
| 4 | Rebaudioside A | 58543-16-1 | β-Glc | 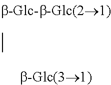 |
| 5 | Rebaudioside B | 58543-17-2 | H | 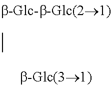 |
| 6 | Rebaudioside C | 63550-99-2 | β-Glc | 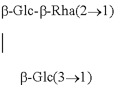 |
| 7 | Rebaudioside D | 63279-13-0 | β-Glc-β-Glc(2→1) | 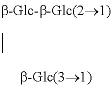 |
| 8 | Rebaudioside E | 63279-14-1 | β-Glc-β-Glc(2→1) | β-Glc-β-Glc(2→1) |
| 9 | Rebaudioside F | 438045-89-7 | β-Glc | 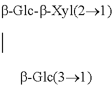 |
| 10 | Rubusoside | 63849-39-4 | β-Glc | β-Glc |
| 11 | Dulcoside A | 64432-06-0 | β-Glc | β-Glc-α-Rha(2→1) |

Steviol glycoside preparations are generally white to light yellow powders that are freely soluble in water and ethanol. The powders can be odorless or have a slight characteristic odor. Aqueous solutions are 200 to 300 times sweeter than sucrose under identical conditions. With its extracts having up to 300 times the sweetness of sugar, stevia has garnered attention with the rise in demand for low-carbohydrate, low-sugar food alternatives.

Medical research has also shown possible benefits of stevia in treating obesity and high blood pressure. Because stevia has a negligible effect on blood glucose, it is attractive as a natural sweetener to people on carbohydrate-controlled diets.

Stevia sweeteners, for example, rebaudioside A (RA), one of the steviol glycosides, is regarded as a promising substitute of sugar, but it still has some drawbacks. When it is dissolved in an aqueous solution, there is a significant taste profile that differs from sugar, such as slow onset, bitterness and a lingering aftertaste. These drawbacks are some of the reasons that have resulted in unsatisfactory acceptable by consumers for stevia sweeteners, such as RA. The taste profile has become a key barrier to the use of stevia sweeteners in food or beverage applications, even if it has been approved as a food additive by the FDA. It is generally recognized that some impurities in stevia sweeteners are related to the aforementioned disadvantages. In recent years, a great deal of focus has been on obtaining a high purity of RA, from the initial 50%, 80%, 90% to the present 95%, 97%, 99%, up to 100%. However, with regard to 100% purity, sensory tests still show that a 200 ppm aqueous solution cannot bring a perfect taste close to sugar, and bitterness and aftertaste issues appear strongly at higher concentrations, for example, at a 500 ppm concentration. As a sweetener and as a promising sugar substitute, the taste of RA etc. must be further improved in order to meet sensory requirements for its applications in food and beverage, especially for use at high concentrations.

Therefore, a need exists for an improved stevia sweetener that overcomes one or more of the current disadvantages noted above.

### BRIEF SUMMARY OF THE INVENTION

The present invention surprisingly provides a stevia sweetener, e.g., one or more steviol glycoside(s), with one or more surfactant(s). The resulting compositions, address one or more of the above-identified current disadvantages of stevia sweeteners.

The present inventors surprisingly found that aqueous RA solutions have specific dispersions and that the dispersions determine the taste profile. Different concentrations of the steviol glycoside material impacts the taste profile. The various dispersions demonstrate that RA molecules do not have a uniform distribution or dispersion in aqueous solutions, such as water. In various aqueous solutions, it was found that several RA molecules associate together to form assembled groups. These assembled groups can be considered as molecular aggregates, colloidal particles, agglomerates, clusters or micelles to describe the assembly of the individual particles of RA in a solution. In the present invention, the term “micelle” will be used to describe these various states of steviol glycosides, such as RA, in solutions.

Thus the present invention provides aqueous micellar dispersions of a stevia sweetener (e.g., one or more steviol glycosides) with one or more surfactants that reduce the agglomeration of the steviol glycoside components, such that sweetness is increased and/or bitterness is decreased (relative to solutions devoid of a surfactant). A multimodal distribution of micelles can be present in the aqueous composition.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### DESCRIPTION OF THE FIGURES

FIG. 1 is a “blank” control sample.

FIG. 2 is control sample 1.

FIG. 3 is control sample 2.

FIG. 4 is a DLS of a 2% solution of RA.

FIG. 5 is a DLS of a 0.8% solution of RA.

FIG. 6 is a DLS of a 500 ppm solution of RA.

FIG. 7 is a DLS of a 500 ppm solution of RA without gum Arabic.

FIG. 8 is a DLS of a 500 ppm solution of RA with 50 ppm gum Arabic.

FIG. 9 is a DLS of a 500 ppm solution of RA with 520 ppm gum Arabic.

### DETAILED DESCRIPTION

In the specification and in the claims, the terms “including” and “comprising” are open-ended terms and should be interpreted to mean “including, but not limited to . . . . ” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

The phrase “stevia sweetener” as referred to herein, pertains to a stevia extract that includes one or more steviol glycosides found in the stevia plant, especially, a stevia extract that comprises RA and one or more steviol glycosides found in the stevia plant. These include, but are not limited to components of stevia such as steviol, steviolbioside, stevioside, rebaudioside A (RA), rebaudioside B (RB), rebaudioside C (RC), rebaudioside D (RD), rebaudioside E (RE), rebaudioside F (RF), rubusoside and dulcoside A.

Typically, the stevia sweetener comprises rebaudioside A and rebaudioside D, or rebaudioside A and stevioside, or rebaudioside A and rebaudioside B.

The present invention provides an improved stevia sweetener, this composition comprises a stevia sweetener (for example, a steviol glycoside) with a surfactant.

A “stevia composition” as referred to herein, therefore includes at least one steviol glycoside, such as RA, and one or more surfactants.

Surfactants are compounds that lower the surface tension of a liquid, allowing easier spreading upon a surface, and lowering of the interfacial tension between two liquids, or between a liquid and a solid. Surfactants may act as detergents, wetting agents, emulsifiers, foaming agents, and/or as dispersants. Surfactants are usually organic compounds that are amphiphilic, meaning they contain both hydrophobic groups (e.g., tails) and hydrophilic groups (e.g., heads). Therefore, a surfactant molecule contains both a water insoluble (or oil soluble component) and a water soluble component. For example, in water, surfactant molecules will migrate to the water surface, where the insoluble hydrophobic group may extend out of the bulk water phase, either into the air or, if water is mixed with an oil, into the oil phase, while the water soluble head group remains in the water phase. This alignment and aggregation of surfactant molecules at the surface, acts to alter the surface properties of water at the water/air or water/oil interface.

The most accepted classification of surfactants is based on their dissociation in water. Generally a surfactant, also called a surface active agent, includes types of ionic surfactant and nonionic surfactants. Ionic surfactants are classified in three general categories: anionic, cationic and zwitterionic (amphoteric) surfactants.

Anionic surfactants have a permanent anion, such as a sulfate, sulfonate and phosphate anion associated with the surfactant or has a pH-dependent anion, for example, a carboxylate.

Sulfates can be alkyl sulfate or alkyl ether sulfates.

Suitable alkyl sulfates include, but are not limited to, ammonium lauryl sulfate or sodium lauryl sulfate (SDS). Suitable alkyl ether sulfates include, but are not limited to, sodium laureth sulfate, also known as sodium lauryl ether sulfate (SLES) or sodium myreth sulfate.

Suitable sulfonates include, but are not limited to, docusate (dioctyl sodium sulfosuccinate), fluorosurfactants that are sulfonated and alkyl benzene sulfonates.

Typical sulfonated fluorosurfactants include, but are not limited to, perfluorooctanesulfonate (PFOS) or perfluorobutanesulfonate.

Phosphates are typically alkyl aryl ether phosphates or alkyl ether phosphates.

Carboxylates are typically alkyl carboxylates, such as fatty acid salts (soaps), such as for example, sodium stearate. Alternatively, the carboxylate can be, but is not limited to, sodium lauryl sarcosinate. In another alternative aspect, the carboxylate includes but is not limited to a carboxylated fluorosurfactant, such as perfluorononanoate, or perfluorooctanoate (PFOA or PFO).

In one aspect, the carboxylate can be attached to a cellulosic structure, such as in carboxymethylcellulose (CMC). Various salts and derivatives of this are available, such as the sodium and calcium salts of CMC. For example, carboxymethylcellulose or cellulose gum is a cellulose derivative with carboxymethyl groups (—CH₂—COOH) bound to some of the hydroxyl groups of the glucopyranose monomers that make up the cellulose backbone. It is often used as its sodium salt, sodium carboxymethyl cellulose.

Carboxymethylcellulose, as is well-known in the art, may have varying degrees of substitution, a “degree of substitution” referring to the number of derivatizing groups, herein carboxymethyl, per each monomer unit on the average. A particularly preferred carboxymethylcellulose has a degree of substitution of about 0.7 and a molecular weight of about 80 kD.

Cationic surfactants are dissociated in water into an amphiphilic cation and an anion, most often as a halogen. This class generally corresponds to nitrogen compounds such as fatty amine salts and quaternary ammoniums, with one or several long alkyl chains derived from natural fatty acids. These surfactants are generally more expensive than anionics, because of a the high pressure hydrogenation reaction to be carried out during their synthesis.

One kind of cationic surfactant is typically based on pH-dependent primary, secondary or tertiary amines. The primary amines become positively charged at a pH<10, and the secondary amines become charged at a pH<4. One example is octenidine dihydrochloride.

Another type of cationic surfactant is based on permanently charged quaternary ammonium cations, such as alkyltrimethylammonium salts. These include but are not limited to cetyl trimethylammonium bromide (CTAB), hexadecyl trimethyl ammonium bromide, cetyl trimethylammonium chloride (CTAC), cetylpyridinium chloride (CPC), polyethoxylated tallow amine (POEA), benzalkonium chloride (BAC), benzethonium chloride (BZT), 5-Bromo-5-nitro-1,3-dioxane, dimethyldioctadecylammonium chloride and dioctadecyldimethylammonium bromide (DODAB).

When a single surfactant molecule exhibits both anionic and cationic dissociations it is called amphoteric or zwitterionic. Zwitterionic (amphoteric) surfactant is based on primary, secondary or tertiary amines or quaternary ammonium cation also having a sulfonate, carboxylate or a phosphate.

Suitable zwitterionic surfactants include, but are not limited to, CHAPS (3-[(3-Cholamidopropyl)dimethylammonio]-1-propanesulfonate) or a sultaine. The sultaine is typically cocamidopropyl hydroxysultaine.

In one aspect, the carboxylate cation is an amino acid, imino acid or betaine. In one aspect, the betaine is typically cocamidopropyl betaine.

When the zwitterionic surfactant includes a phosphate, lecithin is often chosen as the counterion.

Nonionic surfactants are another class of surfactants. They do not ionize in aqueous solution because their hydrophilic group does not dissociate. Suitable hydrophilic groups include alcohols, phenols, ethers, esters, or amides. A large number nonionic surfactants are rendered hydrophilic by the presence of a polyethylene glycol chain obtained by the polycondensation of ethylene oxide.

Nonionic surfactants include, but are not limited to, fatty alcohols, polyoxyethylene glycol alkyl ethers (Brij), polyoxypropylene glycol alkyl ethers, glucoside alkyl ethers, polyoxyethylene glycol octylphenol ethers, polyoxyethylene glycol alkylphenol ethers, glycerol alkyl esters, polyoxyethylene glycol sorbitan alkyl esters, sorbitan alkyl esters, cocamide MEAs, cocamide DEAs, dodecyl dimethylamine oxides, block copolymers of polyethylene glycol and polypropylene glycols.

Suitable fatty alcohols include, but are not limited to, cetyl alcohol, stearyl alcohol, cetostearyl alcohol (consisting predominantly of cetyl and stearyl alcohols) and oleyl alcohol.

Suitable polyoxyethylene glycol alkyl ethers, include but are not limited to (Brij), for example CH₃—(CH₂)₁₀₋₁₆—(O—C₂H₄)₁₋₂₅—OH, or octaethylene glycol monododecyl ether or pentaethylene glycol monododecyl ether.

Suitable polyoxypropylene glycol alkyl ethers include CH₃—(CH2)₁₀₋₁₆—(O—C₃H₆)₁₋₂₅—OH.

Suitable glucoside alkyl ethers include CH₃—(CH₂)₁₀₋₁₆—(O-Glucoside)₁₋₃-OH, and, for example, include decyl glucoside, lauryl glucoside, and octyl glucoside.

Suitable polyoxyethylene glycol octylphenol ethers include C₈H₁₇—(C₆H₄)—(O—C₂H₄)₁₋₂₅—OH. One exemplary material is TRITON X-100.

Suitable polyoxyethylene glycol alkylphenol ethers include C₉—H₁₉—(C₆H₄)—(O—C₂—H₄)₁₋₂₅—OH. One example is Nonoxynol-9.

In one aspect, a suitable glycerol alkyl ester is glyceryl laurate.

In another aspect, a suitable polyoxyethylene glycol sorbitan alkyl ester is polysorbate.

In still another aspect, suitable sorbitan alkyl esters are referred to as SPAN, e.g., SPAN-20, sorbitan monolaurate.

In yet another aspect, suitable block copolymers of polyethylene glycol and polypropylene glycol are typically referred to as poloxamers.

In a micelle, the lipophilic tails of the surfactant molecules remain on the inside of the micelle, due to unfavorable interactions. The polar “heads” of the micelles, due to favorable interactions with water, form a hydrophilic outer layer that in effect protects the hydrophobic core of the micelle. The compounds that make up a micelle are typically amphiphilic in nature, meaning that not only are micelles soluble in protic solvents, such as water, but also in aprotic solvents and can act as a reverse micelle. Surfactants reduce the surface tension of water by adsorbing at the liquid-gas interface. They also reduce the interfacial tension between oil and water by adsorbing at the liquid-liquid interface.

Many surfactants can also assemble in the bulk solution into aggregates. Examples of such aggregates are vesicles and micelles. The concentration at which surfactants begin to form micelle is known as the critical micelle concentration (CMC). When micelles form in water, their tails form a core that can encapsulate an oil droplet, and their (ionic/polar) heads form an outer shell that maintains favorable contact with water. When surfactants assemble in oil, the aggregate is referred to as a reverse micelle. In a reverse micelle, the heads are in the core and the tails maintain favorable contact with oil. Surfactants are also often classified into four primary groups; anionic, cationic, non-ionic, and zwitterionic (dual charge).

Thermodynamics of the surfactant systems are of great importance, theoretically and practically. This is because surfactant systems represent systems between ordered and disordered states of matter. Surfactant solutions may contain an ordered phase (micelles) and a disordered phase (free surfactant molecules and/or ions in the solution).

As mentioned above, nonionic surfactants, for example, a saccharide or a polysaccharide can act as a surfactant and includes edible gums.

The edible gum can be derived from microbial polysaccharides, plant saccharides, marine algal saccharides, or the mixture thereof.

For example, the microbial polysaccharides can be selected from the group of xanthan gum, gellan gum, dextran, scleroglucan, pullulan gum, curdlan and the mixture thereof.

Suitable plant saccharides include pectin, gum arabic, gum tragacanth, karaya gum, guar gum, carob gum, tara gum, konjac gum, tamarind gum, tragacanth, or the mixture thereof.

Suitable marine algal polysaccharides are algin, agar, carrageenan, or the mixture thereof.

In one aspect, the ratio of stevia sweetener to surfactant is from about 1:1 to about 100:1 by weight.

In another embodiment, the ratio of stevia sweetener to surfactant is from about 5:1 to about 20:1 by weight.

In still another embodiment, the ratio of stevia sweetener to surfactant is from about 10:1 by weight.

In a particular embodiment, using the above noted ratios, the preferable surfactant is gum arabic.

After a series of studies on stevia sweetener, the researchers of the present invention have discovered that use of surfactant increased the sweetness and/or decreased the bitterness and/or aftertaste of the stevia sweetener (relative to solutions without a surfactant, for example, gum Arabic).

It has been discovered that the on-set of taste profile is improved after addition of a surfactant. A shorter on-set response is considered advantageous for changing the taste of a stevia sweetener.

Additionally, the lingering profile of stevia sweetener is decreased or eliminated with surfactant.

The present invention provides that RA aqueous solutions filtered with a 0.22 micron membrane still retain some particles which cannot pass through the membrane. This phenomenon indicates that RA molecules have a tendency to aggregate such at a micelle is formed. In other words, molecules of stevia sweetener can be deemed to act as a surfactant. With the addition of a second or additional surfactant(s) (other than the stevia sweetener), the two or more surfactants interact so as to change the status of stevia sweetener in solution.

The present invention surprisingly found that addition of surfactant, for example, gum arabic, as one kind of edible gum, in RA aqueous solutions increased the sweetness of the solution.

In one aspect, the use of a surfactant as an additive can change or adjust the micelles of the steviol components in solution, such that sweetness is increased and/or bitterness is decreased (relative to solutions devoid of a surfactant). A multimodal distribution of micelles can be optimized in the aqueous composition.

In another aspect, the changing or adjusting the micelles of the stevia sweetener can improve an on-set taste profile of stevia sweetener. Under specific conditions, the on-set profile of RA may be modified to be equal to sugar.

In another aspect, the lingering profile (the aftertaste) of a stevia sweetener can be modified by addition of a specific surfactant.

To avoid destroying RA's nature, such as food safety, its natural qualities, and zero calorie aspects, the potential candidates of surfactant should be of corresponding characteristics, like naturally occurring, safe for ingestion, no after taste and/or no caloric content.

As a sweetener, sweet taste acceptance determines market value. Due to bitterness or aftertaste associated with steviol components, there is still a need to eliminate these disadvantages from a stevia sweetener.

The compositions can be used in beverages, broths, and beverage preparations selected from the group comprising carbonated, non-carbonated, frozen, semi-frozen (“slush”), non-frozen, ready-to-drink, concentrated (powdered, frozen, or syrup), dairy, non-dairy, herbal, non-herbal, caffeinated, non-caffeinated, alcoholic, non-alcoholic, flavored, non-flavored, vegetable-based, fruit-based, root/tuber/corm-based, nut-based, other plant-based, cola-based, chocolate-based, meat-based, seafood-based, other animal-based, algae-based, calorie enhanced, calorie-reduced, and calorie-free products, optionally dispensed in open containers, cans, bottles or other packaging. Such beverages and beverage preparations can be in ready-to-drink, ready-to-cook, ready-to-mix, raw, or ingredient form and can use the RA as a sole sweetener or as a co-sweetener.

The compositions can be used in foods and food preparations (e.g. sweeteners, soups, sauces, flavorings, spices, oils, fats, and condiments) from dairy-based, cereal-based, baked, vegetable-based, fruit-based, root/tuber/corm-based, nut-based, other plant-based, egg-based, meat-based, seafood-based, other animal-based, algae-based, processed (e.g. spreads), preserved (e.g. meals-ready-to-eat rations), and synthesized (e.g. gels) products. Such foods and food preparations can be in ready-to-eat, ready-to-cook, ready-to-mix, raw, or ingredient form and can use the RA as a sole sweetener or as a co-sweetener.

The compositions can be used in candies, confections, desserts, and snacks selected from the group comprising dairy-based, cereal-based, baked, vegetable-based, fruit-based, root/tuber/corm-based, nut-based, gum-based, other plant-based, egg-based, meat-based, seafood-based, other animal-based, algae-based, processed (e.g. spreads), preserved (e.g. meals-ready-to-eat rations), and synthesized (e.g. gels) products. Such candies, confections, desserts, and snacks can be in ready-to-eat, ready-to-cook, ready-to-mix, raw, or ingredient form, and can use the composition as a sole sweetener or as a co-sweetener.

The composition can be used in prescription and over-the-counter pharmaceuticals, assays, diagnostic kits, and therapies selected from the group comprising weight control, nutritional supplement, vitamins, infant diet, diabetic diet, athlete diet, geriatric diet, low carbohydrate diet, low fat diet, low protein diet, high carbohydrate diet, high fat diet, high protein diet, low calorie diet, non-caloric diet, oral hygiene products (e.g. toothpaste, mouthwash, rinses, floss, toothbrushes, other implements), personal care products (e.g. soaps, shampoos, rinses, lotions, balms, salves, ointments, paper goods, perfumes, lipstick, other cosmetics), professional dentistry products in which taste or smell is a factor (e.g. liquids, chewables, inhalables, injectables, salves, resins, rinses, pads, floss, implements), medical, veterinarian, and surgical products in which taste or smell is a factor (e.g. liquids, chewables, inhalables, injectables, salves, resins, rinses, pads, floss, implements), and pharmaceutical compounding fillers, syrups, capsules, gels, and coating products.

The compositions can be used in consumer goods packaging materials and containers selected from the group comprising plastic film, thermoset and thermoplastic resin, gum, foil, paper, bottle, box, ink, paint, adhesive, and packaging coating products.

The compositions described herein can be used in goods including sweeteners, co-sweeteners, coated sweetener sticks, frozen confection sticks, medicine spoons (human and veterinary uses), dental instruments, pre-sweetened disposable tableware and utensils, sachets, edible sachets, potpourris, edible potpourris, artificial flowers, edible artificial flowers, clothing, edible clothing, massage oils, and edible massage oils.

The compositions described herein can also be used with “artificial sweeteners”. Artificial sweeteners are those, other than sucrose, such as cyclamates and salts thereof, sucralose, aspartame, saccharin and salts thereof, stevia (Truvia™), rebaudioside A, xylitol, acesulfame-K and the like.

According to variations in temperature, pH value, concentration, viscosity, etc., the user can choose or adjust kinds, types, other parameters of surfactant to achieve the desired technical purpose, based on the principles of the present invention.

The following paragraphs enumerated consecutively from 1 through 35 provide for various aspects of the present invention. In one embodiment, in a first paragraph (1), the present invention provides
1. An improved stevia sweetener composition, comprising stevia sweetener and a surfactant.
2. The improved stevia sweetener composition according to paragraph 1, wherein the surfactant is an ionic surfactant and/or a nonionic surfactant, or mixtures thereof.
3. The improved stevia sweetener composition according to paragraph 2, wherein the ionic surfactant is an anionic surfactant, a cationic surfactant or a zwitterionic (amphoteric) surfactant.
4. The improved stevia sweetener composition according to paragraph 3, wherein the anionic surfactant is a sulfate, a sulfonate, a phosphate, a carboxylate, or mixtures thereof.
5. The improved stevia sweetener composition according to paragraph 4, wherein the sulfate is an alkyl sulfate or an alkyl ether sulfate.
6. The improved stevia sweetener composition according to paragraph 5, wherein the alkyl sulfate is an ammonium lauryl sulfate, or a sodium lauryl sulfate (SDS).
7. The improved stevia sweetener composition according to paragraph 5, wherein the alkyl ether sulfate is a sodium laureth sulfate or a sodium myreth sulfate.
8. The improved stevia sweetener composition according to paragraph 4, wherein the sulfonate is a docusate, a sulfonate fluorosurfactant, an alkyl benzene sulfonate, or mixtures thereof
9. The improved stevia sweetener composition according to paragraph 8, wherein the docusate is a dioctyl sodium sulfosuccinate.
10. The improved stevia sweetener composition according to paragraph 8, wherein the sulfonate fluorosurfactant is perfluorooctanesulfonate (PFOS) or perfluorobutanesulfonate.
11. The improved stevia sweetener composition according to paragraph 4, wherein the phosphate is an alkyl aryl ether phosphate, an alkyl ether phosphate, or mixtures thereof.
12. The improved stevia sweetener composition according to paragraph 4, wherein the carboxylate is an alkyl carboxylate, a sodium lauryl sarcosinate, a carboxylate fluorosurfactants, or mixtures thereof.
13. The improved stevia sweetener composition according to paragraph 12, wherein the alkyl carboxylate is a fatty acid salt.
14. The improved stevia sweetener composition according to paragraph 13, wherein the fatty acid salt is sodium stearate.
15. The improved stevia sweetener composition according to paragraph 12, wherein the carboxylate fluorosurfactants is a perfluorononanoate, or a perfluorooctanoate (PFOA or PFO).
16. The improved stevia sweetener composition according to paragraph 3, wherein the cationic surfactant is octenidine dihydrochloride, alkyltrimethylammonium salt, cetylpyridinium chloride (CPC), polyethoxylated tallow amine (POEA), benzalkonium chloride (BAC), benzethonium chloride (BZT), 5-Bromo-5-nitro-1,3-dioxane, dimethyldioctadecylammonium chloride, or dioctadecyldimethylammonium bromide (DODAB).
17. The improved stevia sweetener composition according to paragraph 16, wherein the alkyltrimethylammonium salt is cetyl trimethylammonium bromide (CTAB), hexadecyl trimethyl ammonium bromide, cetyl trimethylammonium chloride (CTAC), or mixtures thereof.
18. The improved stevia sweetener composition according to paragraph 3, wherein the zwitterionic surfactant is a sulfonate, a carboxylate, a phosphate, mixtures thereof.
19. The improved stevia sweetener composition according to paragraph 18, wherein the sulfonate is CHAPS (3-[(3-Cholamidopropyl)dimethylammonio]-1-propanesulfonate) or a sultaine.
20. The improved stevia sweetener composition according to paragraph 19, wherein the sultaine is cocamidopropyl hydroxysultaine.
21. The improved stevia sweetener composition according to paragraph 18, wherein the carboxylate is an amino acid, an imino acid, a betaine, or mixtures thereof.
22. The improved stevia sweetener composition according to paragraph 21, wherein the betaine is a cocamidopropyl betaine.
23. The improved stevia sweetener composition according to paragraph 18, wherein the phosphate is lecithin.
24. The improved stevia sweetener composition according to paragraph 2, wherein the nonionic surfactant is a saccharide or a polysaccharide.
25. The improved stevia sweetener composition according to paragraph 24, wherein the polysaccharide is a microbial polysaccharide, a plant saccharide, a marine algal saccharide, or mixtures thereof.
26. The improved stevia sweetener composition according to paragraph 24, wherein the microbial polysaccharide is xanthan gum, gellan gum, dextran, scleroglucan, pullulan gum, curdlan or mixtures thereof.
27. The improved stevia sweetener composition according to paragraph 24, wherein the plant saccharide is pectin, gum arabic, gum tragacanth, karaya gum, guar gum, carob gum, tara gum, konjac gum, tamarind gum, tragacanth, or mixtures thereof.
28. The improved stevia sweetener composition according to paragraph 24, wherein the marine algal polysaccharide is algin, agar, carrageenan, or mixtures thereof.
29. The improved stevia sweetener composition according to any of paragraphs 1-28, wherein the stevia sweetener is one or more of steviol glycosides.
30. The improved stevia sweetener composition according to paragraph 29, wherein the steviol glycosides is comprised of one or more of steviol, steviolbioside, stevioside, rebaudioside A, rebaudioside B, rebaudioside C, rebaudioside D, rebaudioside E, rebaudioside F, rubusoside and dulcoside A.
31. The improved stevia sweetener composition according to paragraph 30, wherein the steviol glycosides is comprised of stevioside, rebaudioside A, rebaudioside B, rebaudioside D, or mixtures thereof.
32. The improved stevia sweetener composition according to any of paragraphs 1-31, wherein the ratio of stevia sweetener to surfactant is from about 1:1 to about 100:1 by weight.
33. The improved stevia sweetener composition according to paragraph 32, wherein the ratio is from about 5:1 to about 20:1 by weight.
34. The improved stevia sweetener composition according to paragraph 33, wherein the ratio is amount 10:1 by weight.
35. The improved stevia sweetener composition according to any of paragraphs 32-34, wherein the surfactant is gum arabic.

The following paragraphs enumerated consecutively from 1 through 14 also provide for various aspects of the present invention. In one embodiment, in a first paragraph (1), the present invention provides:
1. A stevia sweetener composition, comprising stevia sweetener and a nonionic surfactant comprising a saccharide or a polysaccharide, an anionic surfactant or mixtures thereof.
2. The stevia sweetener composition according to paragraph 1, wherein the polysaccharide is a microbial polysaccharide, a plant saccharide, a marine algal saccharide, or mixtures thereof.
3. The stevia sweetener composition according to paragraph 2, wherein the microbial polysaccharide is xanthan gum, gellan gum, dextran, scleroglucan, pullulan gum, curdlan or mixtures thereof.
4. The stevia sweetener composition according to paragraph 2, wherein the plant saccharide is pectin, gum arabic, gum tragacanth, karaya gum, guar gum, carob gum, tara gum, konjac gum, tamarind gum, tragacanth, or mixtures thereof.
5. The stevia sweetener composition according to paragraph 2, wherein the marine algal polysaccharide is algin, agar, carrageenan, or mixtures thereof.
6. The stevia sweetener composition according to paragraph 1, wherein the anionic surfactant is a carboxymethylcellulose or a carboxymethylcellulose derivative.
7. The stevia sweetener composition according to paragraph 6, wherein the carboxymethylcellulose derivative is a sodium salt of carboxymethylcelluose.
8. The stevia sweetener composition according to paragraph 1, wherein the stevia sweetener comprises one or more steviol glycosides comprising steviol, steviolbioside, stevioside, rebaudioside A, rebaudioside B, rebaudioside C, rebaudioside D, rebaudioside E, rebaudioside F, rubusoside, dulcoside A or mixtures thereof.
9. The stevia sweetener composition according to paragraph 8, wherein the steviol glycoside comprises stevioside, rebaudioside A, rebaudioside B, rebaudioside D, or mixtures thereof.
10. The stevia sweetener composition according to any of paragraphs 1 through 9, wherein the ratio of stevia sweetener to surfactant is from about 1:1 to about 100:1 by weight.
11. The stevia sweetener composition according to paragraph 10, wherein the ratio is from about 5:1 to about 20:1 by weight.
12. The stevia sweetener composition according to paragraph 11, wherein the ratio is amount 10:1 by weight.
13. The stevia sweetener composition according to any of paragraphs 1, 4, or 8 through 12, wherein the surfactant is gum arabic.
14. The stevia sweetener composition according to any of paragraphs 1 or 6 through 12, wherein the surfactant is a carboxymethylcellulose, a sodium salt or a derivative thereof.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

### Example 1

### Sample Preparation

Samples are aqueous solutions of rebaudioside A with various addition of gum Arabic, as below table.

| Sample/aqueous | | |
|---|---|---|
| solution | rebaudioside A/ppm | gum Arabic/ppm |
| 1 | 200 | 20 |
| 2 | 200 | 40 |
| 3 | 200 | 80 |
| 4 | 200 | 0 |
| 5 | 400 | 200 |
| 6 | 400 | 0 |

Taste Procedure:

Group 1: comparison between sample 1 and 2 by 5 experts

Group 2: comparison between sample 3 and 4 by 5 experts

Group 3: comparison between sample 5 and 6 by 5 experts

Test Results:

Group 1: 60% of the experts identified that sample 2 was sweeter than sample 1, and the rest (40%) thought it was difficult to distinguish between them.

Group 2: 60% of the experts identified that sample 3 was sweeter than sample 4, and the rest (40%) thought it was difficult to distinguish them.

Group 3: 80% of the experts identified that sample 5 was sweeter than sample 6.

60% of the experts identified sample 5 as having an improved onset (quick onset);

40% of the experts identified sample 5 as having a less lingering after taste;

All experts thought sample 5 was better tasting than sample 6.

Conclusions:

Addition of gum Arabic increased the sweetness of Reb A aqueous solution.

More addition of gum Arabic brings more increased sweetness of the Reb A aqueous solution.

Addition of gum Arabic decreased the bitterness of Reb A aqueous solution.

Addition of gum Arabic improved the temporal effect of Reb A aqueous solution, such as less lingering (duration of aftertaste) and quick onset.

### Example 2

The goal of this example was to determine whether Reb A aqueous solutions contain Reb A micelles.

Sample Preparation:

1 g 99% Reb A was dissolved in water with or without gum arabic to make an aqueous solution of 500 ppm concentration by weight. The solution was filtered with 0.45 um membrane to get rid of dust or ash from the environment before testing.

Details of samples as below:

| | | Gum | |
|---|---|---|---|
| | Reb A | arabic | Duration between 0.45 um membrane |
| Sample | (ppm) | (ppm) | filtration and testing/(hours) |
| Blank | 500 | 0 | Six |
| Control 1 | 500 | 50 | Six |
| Control 2 | 500 | 50 | Zero |

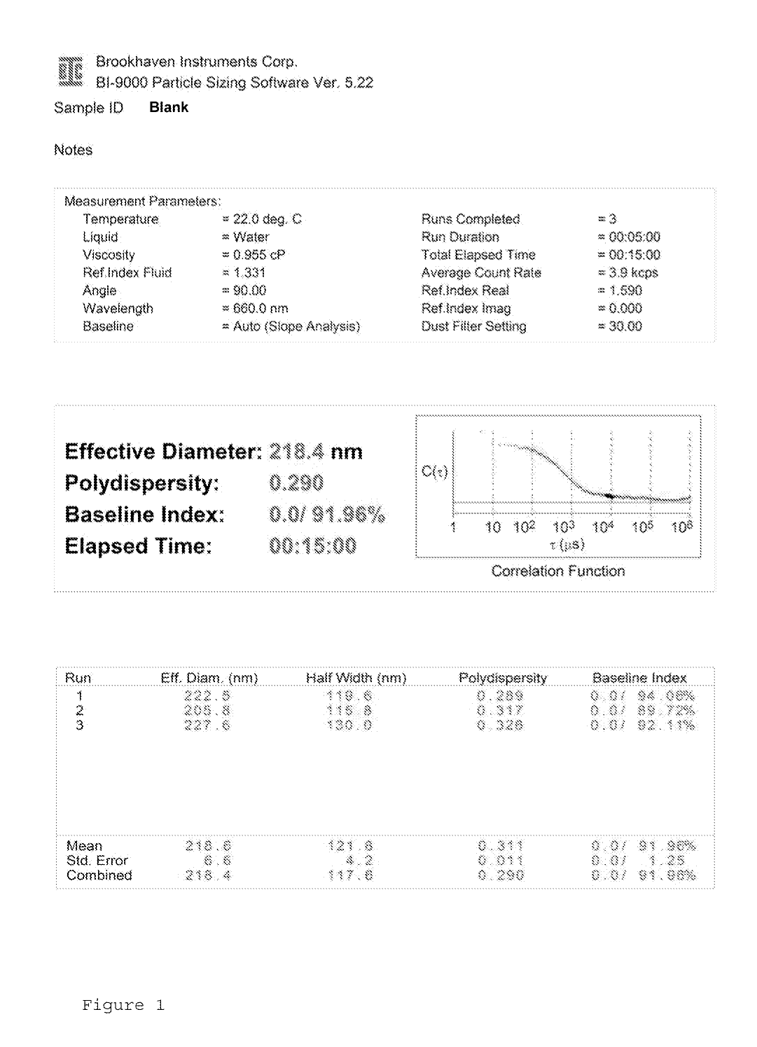

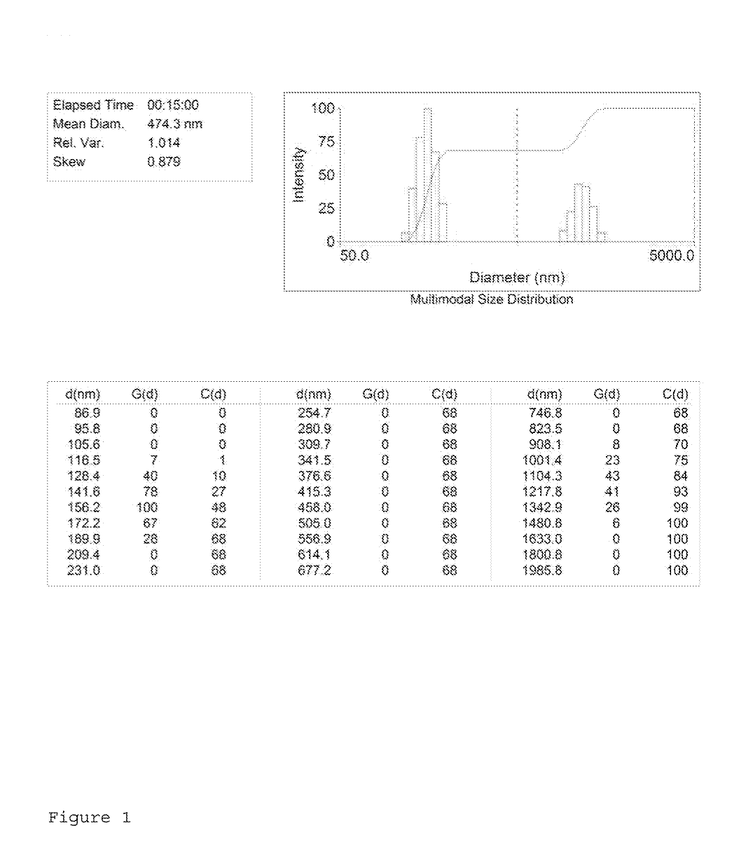

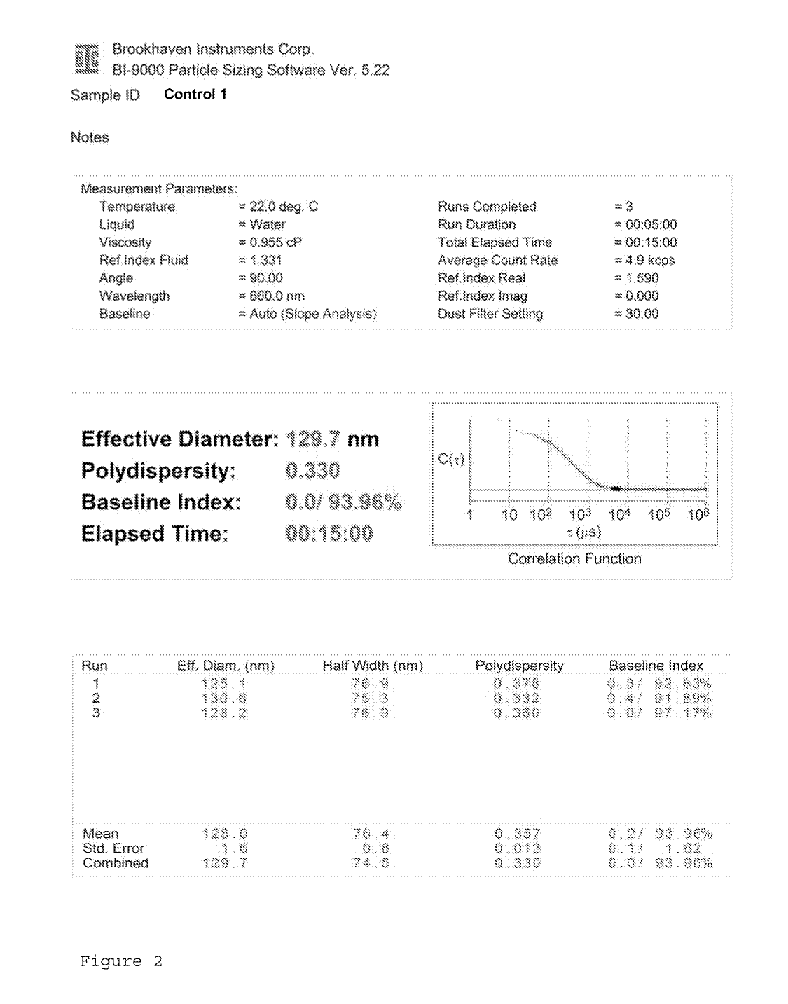

Results: See FIGS. 1, 2 and 3, “Blank”, “Control 1” and “Control 2” respectively.

Conclusions:

From results of “blank” and “control 1”, the size of micelles in the “blank” is bigger than that in “control 1”. Therefore, it was determined that addition of gum arabic is able to decrease the size of micelles in an aqueous solution of Reb A.

The size of micelles in the results of “control 1” is larger than that of “control 2”. This appears to indicate that the size of micelles in solution increases after filtration through a 0.45 membrane over time. Therefore, there is a dynamic balance of micelles in Reb A solution.

### Example 3

The purpose of the example was to verify existence of micelles.

Three concentrations of Reb A aqueous solutions were prepared: 500 ppm, 0.8% and 2.0%.

The 500 ppm is close to the concentration in actual application in food and beverages.

The 0.8% (by weight) is saturated.

The 2.0% (by weight) is over-saturated. After preparation, Reb A will continue to precipitate slowly and finally result in a 0.8% solution.

Before DLS analysis of the 0.8% and 2.0% samples, the solutions were filtered through a 0.45 μm membrane to lower the interference caused by dust or ash present in the environment. For the 500 ppm solution, membrane filtration might have lead to a very low concentration, and impact on accuracy, therefore, no filtration of the sample was performed.

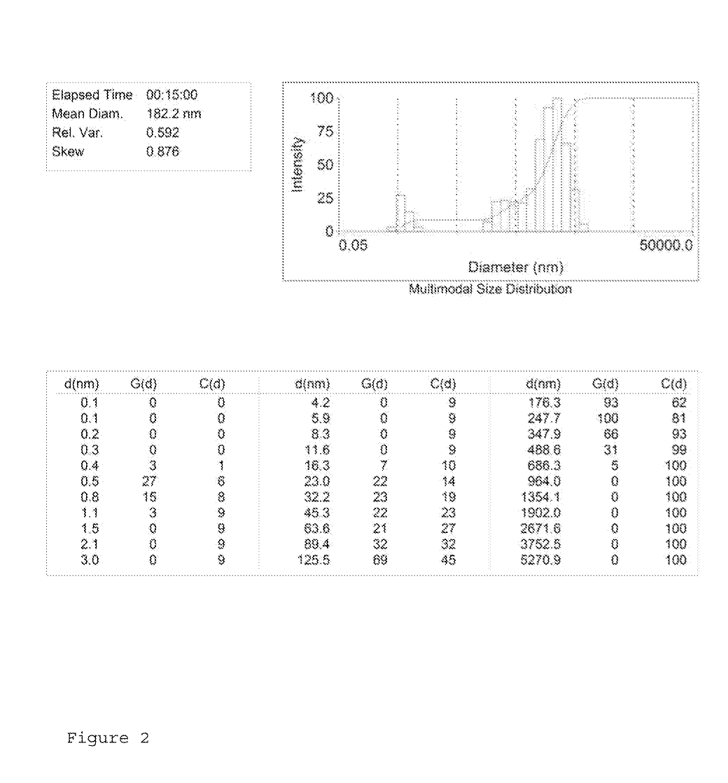

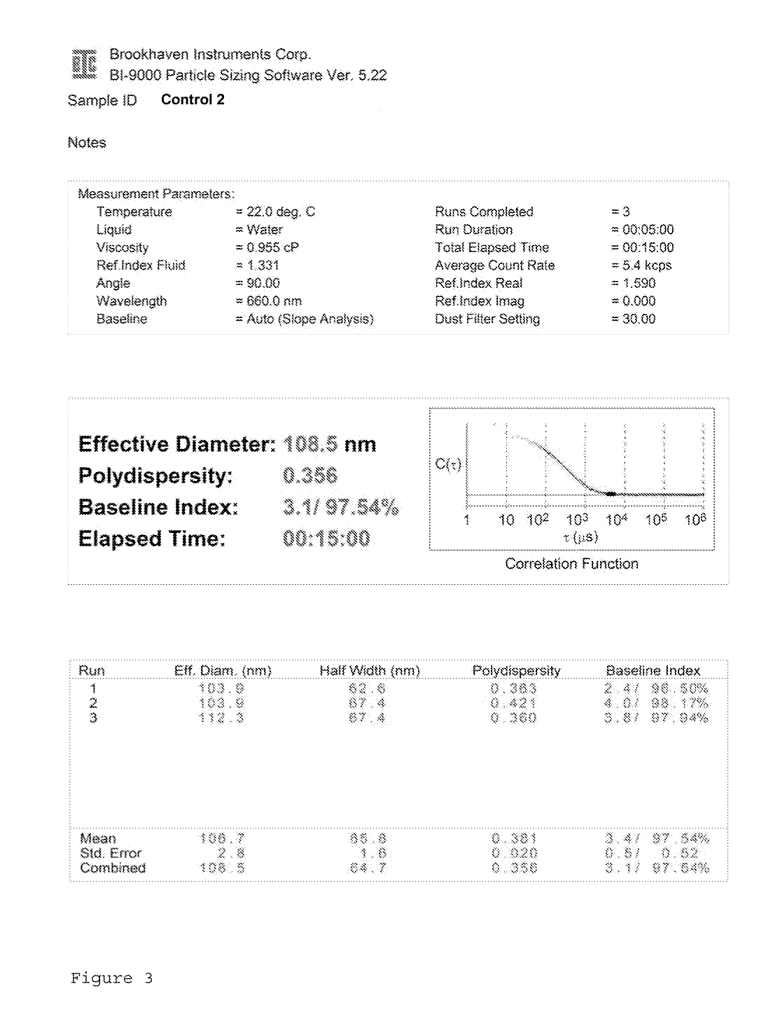

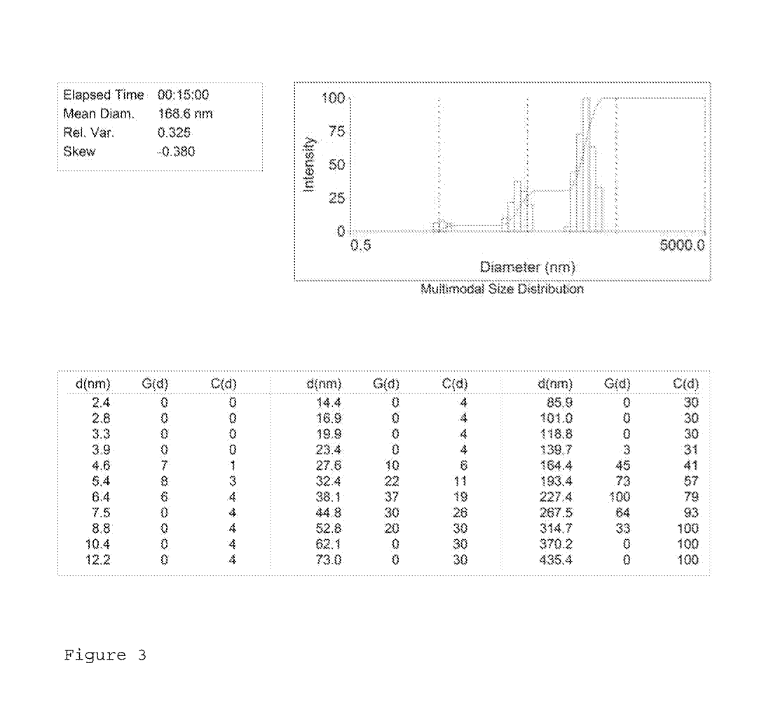

Results are provided in FIGS. 4 through 6.

The results showed that:

In the 2.0% Reb A solution, there are many monomolecules (molecules in a non-clustered state) and/or low molecular weight oligomers with 2-4 nm size, and a portion of micelles having 100-200 nm size. Intensity of vertical axis is in direct ratio of 10⁶ of micelles, which means less micelles with bigger size contribute a main part of intensity, and more particles with smaller size cause a little intensity.

In the 0.8% Reb A solution, in much the same manner, monomolecules and/or low molecular weight oligomers with 2-4 nm size and clusters having 100-200 nm size exist. However, the amount of monomolecules is decreased relative to those in the 2.0% solution.

In the 500 ppm Reb A solution, there are particles larger than 1000 μm in size. This might be because of no filtration by 0.45 μm membrane, but it could not be determined if they are dust or Reb A micelles. There were no monomolecules and/or low molecular weight oligomers less than 50 nm in size, however, 250-450 nm micelles were observed.

According to the above, it was concluded that:

There are micelles in Reb A solution.

With increasing concentration from 500 ppm to 0.8% and 2.0%, the percentage of monomolecules and/or low molecular weight oligomers increased gradually.

Reb A clusters in solution be not a simple ball-shaped micelles, but irregular big clusters with a broad range of size.

### Example 4

This example verifies gum Arabic's action. Tables provided below provide taste profile evaluations.

Table 1: 200 ppm 99% RA+20 ppm gum Arabic have an increased sweetness.

TABLE 1

| expert | 200 ppm 99% RA | 200 ppm 99% RA + 20 ppm gum Arabic |
|---|---|---|
| 1 | Good taste | Obvious increased sweetness by at least one |
| | | factor |
| 2 | Good taste | Obvious increased sweetness, with little |
| | | astringent |
| 3 | little astringent | Obvious increased sweetness |
| 4 | Good taste | Obvious increased sweetness |
| 5 | Good taste | Obvious increased sweetness |

TABLE 2
No obvious difference was discerned between the inclusion of gum
Arabic or no gum Arabic. These results indicate that 100 ppm of RA
is too low and addition of gum Arabic does not alter the taste profile.

| expert | 100 ppm 99% RA | 100 ppm 99% RA + 10 ppm gum Arabic |
|---|---|---|
| 1 | No difference | |
| 2 | | sweeter |
| 3 | No difference | |
| 4 | | sweeter |
| 5 | | sweeter |

TABLE 3
Provides a comparison between 200 ppm and 150 ppm
aqueous solutions of RA. 150 ppm of RA provides a mild sweetness and
people can accept it. Addition of gum Arabic further elevates sweetness.

| expert | 150 ppm RA | 150 ppm RA + 15 ppm gum Arabic |
|---|---|---|
| 1 | Not bad sweetness | Elevated sweetness |
| 2 | Not bad sweetness | Elevated sweetness |
| 3 | Less sweetness | Elevated sweetness |
| 4 | Not bad sweetness | Elevated sweetness |

TABLE 4
500 ppm RA provides a very high sweetness and gum
Arabic cannot improve sweetness better.

| expert | 500 ppm RA | 500 ppm RA + 20 ppm gum Arabic |
|---|---|---|
| 1 | No difference | |
| 2 | | sweeter |
| 3 | No difference | |
| 4 | | sweeter |

TABLE 5
1% sucrose solution is tasteless.

| | | |
|---|---|---|
| expert | 1% sucrose | 1% sucrose + 0.1% gum Arabic |

| | |
|---|---|
| 1 | Tasteless |
| 2 | Tasteless |
| 3 | Tasteless |
| 4 | Tasteless |

TABLE 6
addition of gum Arabic does not elevate sweetness.

| | | |
|---|---|---|
| expert | 8% sucrose | 8% sucrose + 0.8% gum Arabic |

| | |
|---|---|
| 1 | No difference |
| 2 | No difference |
| 3 | No difference |
| 4 | No difference |

Conclusions: addition of gum Arabic elevates sweetness of Reb A solution, and does not improve the sweetness of the sucrose solution.

### Example 5

This example was for size determination.

The solutions noted below were filtered with a 0.45 μm membrane.

500 ppm RA

500 ppm RA+50 ppm gum Arabic

500 ppm RA+250 ppm gum Arabic

Measurements were obtained by DLS after the solution was filtered and allowed to equilibrate for six hours.

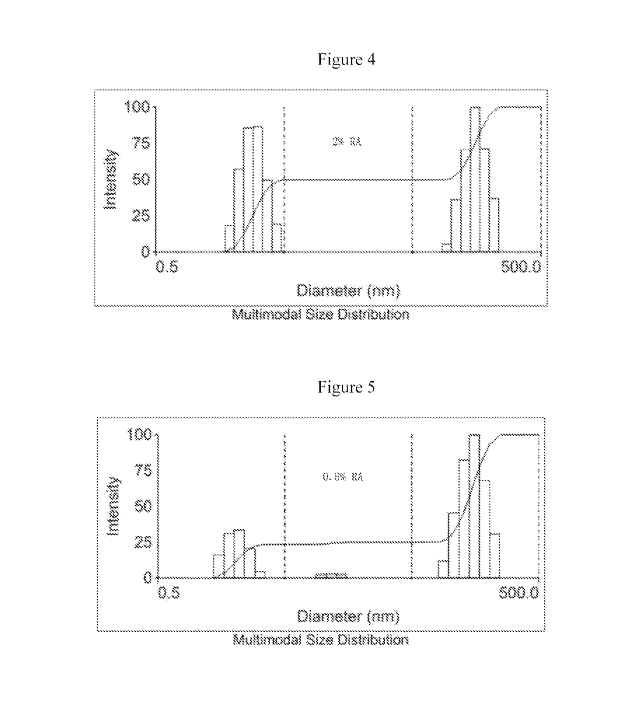

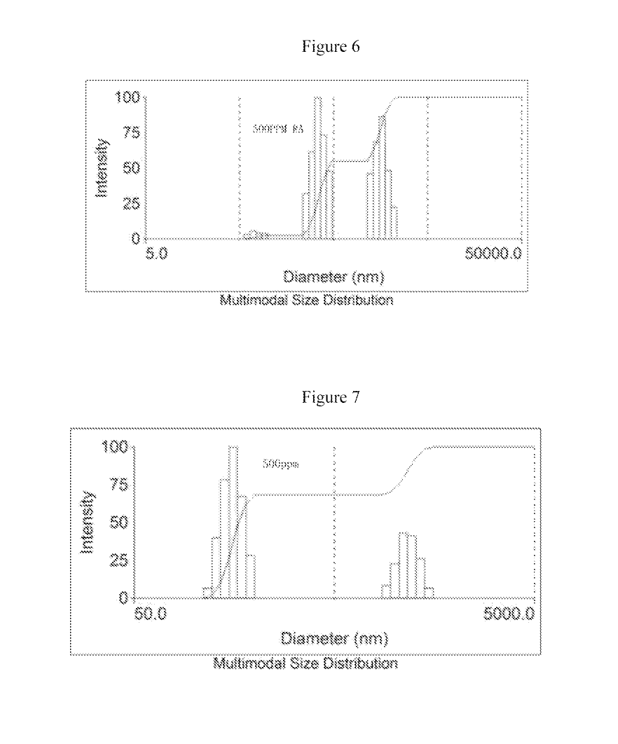

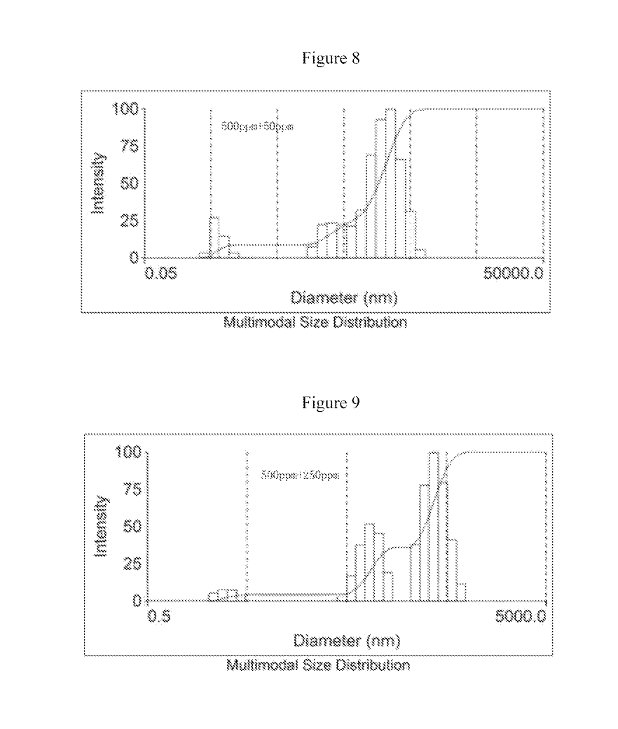

According to FIGS. 7 through 9, it was determined that:

A decreased amount of micelles with size greater than 1000 nm reappear in 500 ppm Reb A solution after six-hours of standing.

In the 500 ppm RA+50 ppm gum Arabic solution, 16-90 nm size micelles appeared after adding gum Arabic; in the meantime, less 480-690 nm size micelles appear as compared to 500 ppm without gum Arabic.

In the 500 ppm RA+250 ppm gum Arabic solution, small-size micelles appeared. The micelle size tended to go bigger as compared to 500 ppm without gum Arabic.

Conclusions:

Reb A solution is unstable, and molecules of Reb A go together by natural forces.

Addition of gum Arabic can diminish Reb A's micelles size and slow down the process of physical aggregation, or change the upper limit of Reb A micelle size.

Reb A molecules aggregate to form micelles in solution and have a tendency to form above 1000 nm in size.

With an increase in concentration of Reb A in solution, the monomolecule's percentage increases relative to the percentage of micelles.

Thus not to be limited by theory, it is believed that reduction or elimination of monomolecules and/or low molecular weight oligomers of RA or other stevia components reduces or eliminates bitterness of a given composition. Inclusion of one or more surfactants increases sweetness relative to a composition without the surfactant, such as gum Arabic.

### Example A

### Sample Preparation

Samples are aqueous solutions of rebaudioside A with various additions of sodium carboxymethylcellulose, as provided in the table below.

| Sample/aqueous | | sodium |
|---|---|---|
| solution | rebaudioside A/ppm | carboxymethylcellulose/ppm |
| 1 | 200 | 20 |
| 2 | 200 | 40 |
| 3 | 200 | 80 |
| 4 | 200 | 0 |
| 5 | 400 | 200 |
| 6 | 400 | 0 |

Taste Procedure:

Group 1: comparison between sample 1 and 2 by 7 experts

Group 2: comparison between sample 3 and 4 by 7 experts

Group 3: comparison between sample 5 and 6 by 7 experts

Test Results:

Group 1: 85.7% of the experts identified that sample 2 was sweeter than sample 1, and the rest thought it was difficult to distinguish between them.

Group 2: 100% of the experts identified that sample 3 was sweeter than sample 4.

Group 3: 100% of the experts identified that sample 5 was sweeter than sample 6.

Conclusions:

Addition of sodium carboxymethylcellulose increased the sweetness of Reb A aqueous solution.

Increased amounts of sodium carboxymethylcellulose brings more increased sweetness of the Reb A aqueous solution.

### Example B

This example demonstrated that the addition of sodium carboxymethylcellulose can increase sweetness of an Reb A solution, and does not improve the sweetness of sucrose solutions of equal concentrations.

Sample Preparation:

200 ppm 99% RA

200 ppm 99% RA+20 ppm sodium carboxymethylcellulose

Seven experts executed taste evaluation. Results as noted in the table below

| Expert | 200 ppm 99% RA | 200 ppm 99% RA + 20 ppm sodium carboxymethylcellulose |
|---|---|---|
| 1 | Good taste | Good taste and obvious increased sweetness than RA alone |
| 2 | little astringent | Obvious increased sweetness, with little astringent |
| 3 | Good taste | Good taste and obvious increased sweetness than RA alone |
| 4 | Good taste | Good taste and obvious increased sweetness than RA alone |
| 5 | Good taste | Good taste and obvious increased sweetness than RA alone |
| 6 | Good taste | Good taste and obvious increased sweetness than RA alone |
| 7 | Good taste | Good taste and obvious increased sweetness than RA alone |

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A stevia sweetener composition, comprising stevia sweetener and a nonionic surfactant comprising a saccharide or a polysaccharide, an anionic surfactant or mixtures thereof.

2. The stevia sweetener composition according to claim 1, wherein the polysaccharide is a microbial polysaccharide, a plant saccharide, a marine algal saccharide, or mixtures thereof.

3. The stevia sweetener composition according to claim 2, wherein the microbial polysaccharide is xanthan gum, gellan gum, dextran, scleroglucan, pullulan gum, curdlan or mixtures thereof.

4. The stevia sweetener composition according to claim 2, wherein the plant saccharide is pectin, gum arabic, gum tragacanth, karaya gum, guar gum, carob gum, tara gum, konjac gum, tamarind gum, tragacanth, or mixtures thereof.

5. The stevia sweetener composition according to claim 2, wherein the marine algal polysaccharide is algin, agar, carrageenan, or mixtures thereof.

6. The stevia sweetener composition according to claim 1, wherein the anionic surfactant is a carboxymethylcellulose or a carboxymethylcellulose derivative.

7. The stevia sweetener composition according to claim 6, wherein the carboxymethylcellulose derivative is a sodium salt of carboxymethylcelluose.

8. The stevia sweetener composition according to claim 1, wherein the stevia sweetener comprises one or more steviol glycosides comprising steviol, steviolbioside, stevioside, rebaudioside A, rebaudioside B, rebaudioside C, rebaudioside D, rebaudioside E, rebaudioside F, rubusoside, dulcoside A or mixtures thereof.

9. The stevia sweetener composition according to claim 8, wherein the steviol glycoside comprises stevioside, rebaudioside A, rebaudioside B, rebaudioside D, or mixtures thereof.

10. The stevia sweetener composition according to claim 1, wherein the ratio of stevia sweetener to surfactant is from about 1:1 to about 100:1 by weight.

11. The stevia sweetener composition according to claim 1, wherein the surfactant is gum Arabic.

12. The stevia sweetener composition according to claim 4, wherein the surfactant is gum Arabic.

13. The stevia sweetener composition according to claim 8, wherein the surfactant is gum Arabic.

14. The stevia sweetener composition according to claim 9, wherein the surfactant is gum Arabic.

15. The stevia sweetener composition according to claim 10, wherein the surfactant is gum Arabic.

16. The stevia sweetener composition according to claim 1, wherein the surfactant is a sodium carboxymethylcellulose.

17. The stevia sweetener composition according to claim 8, wherein the surfactant is a sodium carboxymethylcellulose.

18. The stevia sweetener composition according to claim 9, wherein the surfactant is a sodium carboxymethylcellulose.

19. The stevia sweetener composition according to claim 10, wherein the surfactant is a sodium carboxymethylcellulose.
